(19) United States
(12) Patent Application Publication
(10) Pub. No.: US 2015/0292197 A1
(43) Pub. Date: Oct. 15, 2015

(54) Rodent-Resistant, Reinforced Weather Stripping

(71) Applicants: Samuel Miller, San Francisco, CA (US); Arlene Miller, San Francisco, CA (US)

(72) Inventors: Samuel Miller, San Francisco, CA (US); Arlene Miller, San Francisco, CA (US)

(21) Appl. No.: 14/251,422

(22) Filed: Apr. 11, 2014

(51) Int. Cl. E04B 1/72; E04B 1/66; E06B 7/232

(52) U.S. Cl. CPC E04B 1/72; E06B 7/232; E04B 1/66

(57) ABSTRACT

The present invention relates to door sweeps and door thresholds, also known as weather stripping. More specifically, the invention relates to modified door sweeps having steel sheeting or steel mesh fully embedded in a flexible polymer as to provide an effective barrier between an area such as a room in a home or a garage and the outside, by preventing rodent destruction or circumvention of the sweep.

### CROSS-REFERENCE TO RELATED APPLICATIONS

None.

### FEDERALLY-SPONSORED RESEARCH

Not applicable.

### SEQUENCE LISTING

Not applicable.

### FIELD OF THE INVENTION

The present invention relates to door sweeps and door thresholds, also known as weather stripping. More specifically, the invention relates to modified door sweeps having steel sheeting or steel mesh fully embedded in a flexible polymer as to provide an effective barrier between an area—such as a room in a home or a garage—and the outside, by preventing rodent destruction or circumvention of the sweep.

### BACKGROUND

It is well known in the building industry that the lower edges of doors and windows spread more or less from the adjacent face of the threshold, making an opening which admits insects, rodents, cold air, sleet, snow, etc., into the building, room or garage at the floor level. To address this problem, weather strips are used to limit the passage of unwelcome entrants under or between doors and windows. Unfortunately, a weather strip is only efficacious to the extent it remains whole and properly positioned, and rodent degradation is a common hindrance to such efficacy. While current door sealing systems have generally proven to be satisfactory for their applications, each is associated with its share of limitations and almost all suffer from susceptibility to rodent damage, as rodents can effectively chew through most non-steel materials.

Weather stripping generally consists of a sweep, which is located at the bottom of most entry doors or windows to assist in sealing the opening between the door or window and a horizontal surface, and a threshold cap, which makes contact with the door sweep to seal and help prevent water, air and pests from passing beyond the threshold. As rodents chew at the edges of the sweep, the door sweep becomes deformed, losing its shape and ultimately leaving gaps in the seal thus compromising the integrity of the entire seal. This permits water, air and pests to pass beyond the threshold.

What is needed is an inexpensive, practical rodent-resistant version of the common door sweep that can be used on inner doors, entryway doors, garages and windows alike.

### SUMMARY OF THE INVENTION

In accordance with the teachings of the present invention, provided is a rodent-resistant, reinforced weather strip that is reliably insusceptible to penetration and, thus, reliably aligns with the target surfaces and seal to prevent water, air and pests from crossing the threshold of a door.

A modified weather strip includes a threshold cap with means for attaching the weather strip to the door, garage or window (generally, the “barrier”) and a sweep, which effectively closes the gap between the barrier and the horizontal surface just below the barrier (generally, the “threshold”). Unlike other commercially available vinyl weather stripping, the sweep of the modified weather strip contains a strip of rodent-resistant material, such as steel mesh or steel sheeting, that is entirely embedded in the polymer and runs the full length of the sweep.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

FIG. 1 shows the front-side view of one embodiment of the modified weather strip.

FIG. 2 shows the front-side deconstructed view of one embodiment of the modified weather strip.

FIG. 3 shows the side view of one embodiment of the modified weather strip.

### DETAILED DESCRIPTION

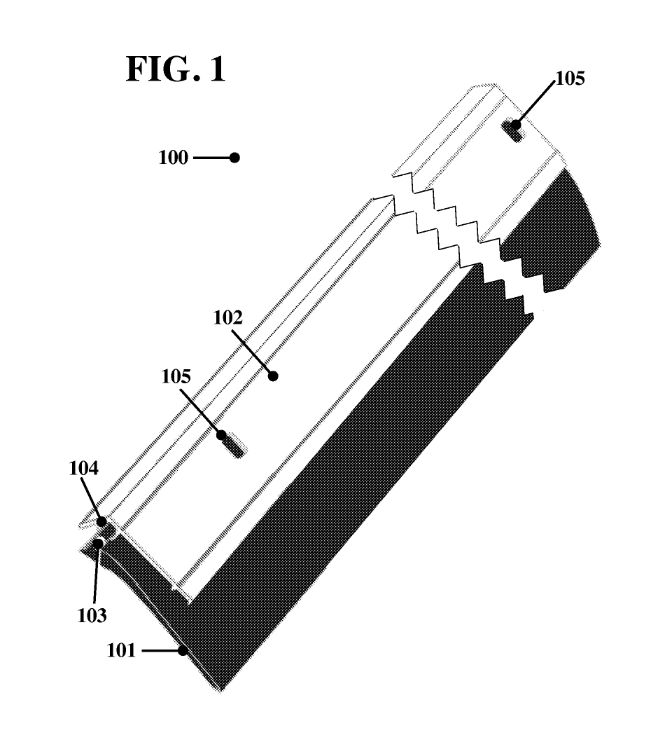

FIG. 1 shows a perspective view 100 of one embodiment of the modified weather strip having a sweep 101 and a threshold cap 102. As depicted, the sweep is positioned behind the threshold cap and engaged with the cap via insertion of a lip 103 connected to and running the length of the sweep into a complimentary track 104 inset and running the length of the threshold cap. Further depicted are two attachment means shown as holes 105 in the front plate of the threshold cap 102 through which nails or screws can pass and be further inserted into the bottom of the target barrier (e.g., door, garage or window) as to secure the weather strip to the barrier.

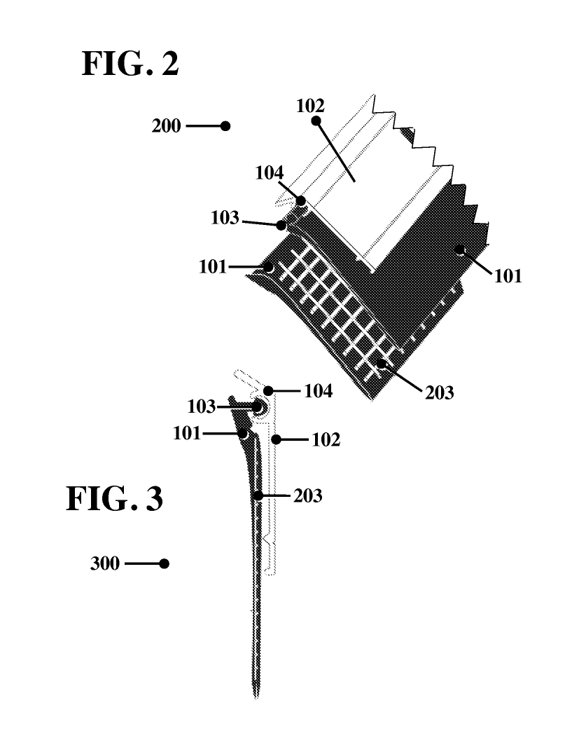

FIG. 2 shows the deconstructed perspective view 200 of one embodiment of the modified weather strip having a sweep depicted as comprising a back layer 201 and a front layer 202 of suitable polymer sandwiching a layer of steel mesh 203 running the near-full width and length of the polymer as to provide maximum protection against rodent degradation while being fully and safely embedded in the polymer. While steel mesh is depicted, an alternative rodent-resistant material, such as sheet metal, can be used. The sweep is positioned behind the threshold cap 204 and attached thereto via insertion of a lip 205 connected to and running the length of the sweep into a complimentary track 105 inset and running the length of the threshold cap.

FIG. 3 shows the vertical cross-section 300 of one embodiment of the modified weather strip having a sweep 301 and a threshold cap 302. As depicted, the sweep is positioned behind the threshold cap and engaged with the cap via insertion of a lip 303 connected to and running the length of the sweep into a complimentary track 304 inset and running the length of the threshold cap. Further depicted is a layer of steel mesh 305 fully embedded in the polymer of the sweep 301.

In position, the modified weather strip attaches by the threshold cap just above the lower edge of the barrier as to extend the sweep downward, fully covering any opening between the barrier and the threshold and thereby impenetrably sealing off outside elements from crossing the threshold.

As to further discussion of the manner of usage and operation of the present invention, the same should be apparent from the above description. With respect to the above description then, it is to be realized that the optimum dimensional relationships for the parts of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention, the use of which results in a conventional weather strip that prevents rodent degradation. Although the description presented heretofore contains specificities for the benefit of illustration, these should not be construed as limiting the scope of the embodiments but rather as illustrative examples of some of the several embodiments.

1. A weather strip for doors, hinged windows and the like comprising:
a first elongated strip comprising a first material. a second material and a means for integration, the first and second materials being substantially layered relative to one another such that the first material is positioned between and substantially enveloped by two layers of the second material, said first material being rigid and impenetrable relative to said second material, said second material being non-porous and flexible relative to said first material;
a rigid means for attachment comprising a second elongated strip, a complementary means for integration for securely attaching said first elongated strip to the means for attachment via interconnection with said means for integration, and a means for installation, said second elongated strip being substantially L-shaped in cross section and having an upper flange and an outer member, the upper flange thereof adapted to be fixed near the bottom of a door or window and the outer member of the second elongated strip extending in a plane at an obtuse angle to the upper flange and in parallel relation to said door or window.

2. The weather strip for doors, hinged windows and the like of claim 1 wherein the first material is either sheet metal or metal mesh.

3. The weather strip for doors, hinged windows and the like of claim 1 wherein the integration means is a lip composed of the second material of the elongated strip, said lip extending outward from one face of the elongated strip and running substantially the length of the elongated strip.

4. The weather strip for doors, hinged windows and the like of claim 1 wherein the complementary integration means is a track of a shape and size substantially complementary to the shape and size of the integration means of the elongated strip.

5. The weather strip of claim 1 wherein said first material is vinyl polymer.

6. The weather strip of claim 1 wherein said means for installation is holes of standard number and size for securing the weather strip to a sash frame or window via screws or an adhesive backing
